(19) United States
(12) Patent Application Publication
(10) Pub. No.: US 2008/0046557 A1
(43) Pub. Date: Feb. 21, 2008

(54) Method and system for designing, implementing, and managing client applications on mobile devices

(76) Inventor: Joseph C. Cheng, Carlisle, MA (US)

Correspondence Address: DORIS L CHENG, 29 OAK KNOLL RD, CARLISLE, MA, 01741, US

(21) Appl. No.: 11/385,636

(22) Filed: Mar. 21, 2006

Related U.S. Application Data
(60) Provisional application No. 60/664,416, filed on Mar. 23, 2005.
(60) Provisional application No. 60/677,380, filed on May 3, 2005.

(51) Int. Cl. H04N 7/173; G06F 15/16; G06F 15/173

(52) U.S. Cl. 709/224; 725/86; 709/217

(57) ABSTRACT

A system that designs, implements, and manages client applications on mobile devices using runtime executives and an IDE. In one aspect, the runtime executive delivers consistent GUI and application behavior within and across mobile development platforms. In another aspect, the runtime executive can set up data files of an IDE-generated client application on mobile devices and then become that application itself while supporting a pay-per-download subscription service. The runtime executive delivers multimedia content in presentation format via a one-level browsing interface, enables data entries across tabbed views with minimal typing and drilidowns via a one-level data entry interface, and precisely processes scripts and commands, including calls to COM libraries. The IDE allows non-programmers to design the GUI and the scripts for mobile device applications and compile them into application data files for multiple development platforms, which are then loaded and executed by runtime executives.

### CROSS-REFERENCE TO RELATED APPLICATIONS

This application claims the benefit of U.S. Provisional Patent Application Nos. 60/664,416 and 60/677,380, filed on Mar. 23, 2005 and May 3, 2005 respectively. Both entitled “Application Portal and Platform for Managing Dynamically Configurable Applications on Mobile Devices.”

### BACKGROUND OF THE INVENTION

1. Field of the Invention

The present invention relates to client applications on mobile devices and, more specifically, to methods and systems providing consistent graphical user interface (GUI) and application behavior within and across multiple mobile development platforms while supporting a pay-per-download subscription service.

2. Description of Related Art

Cell phones are emerging as the third screen behind TVs and computers to enrich work and lifestyle experiences. Advantages include mobility & immediacy, while limitations include small screen sizes, memory and storage capacities, and battery life. Despite recent Internet access developments such as the wireless application protocol (WAP) technology, usage can often be held back by factors including costly over-the-air downloads, the difficulty of correctly typing an URL on a 10-key dial pad, and the slowness of network connections, while the functionality of client applications can be held back by program size, memory and data storage constraints set by the device manufacturers, the cell phone service providers (also known as carriers), and the underlying application platforms collectively.

The current user interface of many wireless applications requires users to step through layers of menu options in an exact sequence to get to the information they want. Users can easily get lost while moving through a navigation sequence, especially if it is necessary to go back to previous screens in order to change previous selections. Thus, there is a need for techniques that provide users with one-level browsing and data collection functions in client applications.

Due to potential file and data storage limitations, users can often only keep a small number of applications on their cell phones. Installing a new application may necessitate the deletion of another application on the device in order to free up the storage. This is because each application has its own non-shareable runtime executive and data files. Thus, there is a need for techniques to make one runtime executive to drive all client applications of the same development platform. This way, exchanging applications under the pay-per-download model is simply a matter of replacing a set of data files while the runtime executive stays intact on a mobile device, with the benefit of faster download and lower cost.

Typically, wireless applications are not portable across mobile device platforms such as Java 2 Micro Edition (J2ME) or Binary Runtime Environment for Wireless (BREW) without extensive customization. As users switch from one cell phone service provider (also known as carrier) to another, they may forfeit access to some of their favorite applications depending on the new carrier's platform coverage. Therefore, there is a need for an integrated development environment (IDE) capable of generating code for multiple mobile platforms from the same design files. As a result, such an IDE can shorten the time to develop, test, market, and support new wireless applications. Together with the runtime executive, the same client application will have consistent GUI and application behavior within and across different development platforms.

### BRIEF SUMMARY OF THE INVENTION

Broadly speaking, the invention relates to techniques to (a) build client applications on mobile devices with consistent graphical user interface (GUI) and application behavior within and across multiple mobile development platforms, and (b) support a pay-per-download subscription service. In one aspect of the invention, compact and shareable runtime executives are provided to deliver PC-like interactive navigation, multimedia presentations, and data manipulations. In another aspect of the invention, an IDE is provided for designing client applications that can be compiled for various development platforms and loaded by runtime executives to speed up the ease of customization and the time to market while supporting a pay-per-download subscription model.

A runtime executive of the invention is capable of performing complex tasks with simple GUI and navigation schemes while working within the resource constraints of the devices themselves and those set by the development platforms. On one hand, a runtime executive is the engine that drives all IDE-generated client applications of the same development platform. On the other hand, it can be tailored to the underlying development platform to leverage the features of that particular development platform. Furthermore, it can function as a loader to exchange the client application(s) per valid user request and make pay-per-download subscription model a reality. Currently two embodiments have been implemented, one for devices running the Java 2 Micro Edition (J2ME) platform and the other for devices running the Binary Runtime Environment for Wireless (BREW) platform. Both runtime executives have a small operational footprint and can host client applications to govern the execution of business rules, application logic, data model, navigation, and GUI on mobile devices with limited resources. In contrast to the J2ME runtime executive, the BREW runtime executive can host a suite of distinct wireless applications for one subscription service. As a result, subscribers can access these applications through icons in one screen as if they were icons on a PC desktop.

To add more functions to client applications, a runtime executive of the invention is capable of processing the scripts written & compiled in an integrated development environment (IDE). The scripted representation of workflow, business rules, application logic, and data model enables a user to search and query the databases (on a server; or in the cache memory or persistent storage on a mobile device), and to look up the results in presentation format, while being able to add, edit, and browse records with automatic data integrity checks. For example, the scripted command macros for managing the workflow detail what needs to get done, how and under what circumstances, and an alternate course of action that can be processed in the background without distracting the user.

To give users easy access to the information they want in presentation style, a runtime executive of the invention can provide the one-level content browsing interface. In one embodiment of the one-level content browsing interface, a photo/content gallery allows the right/left button clicks to open the next or previous view of the current object, which can be an image, a bulleted list, or a numbered list about that object. Also, it allows the up/down button clicks to bring up the anchor view of the previous or next object in the gallery, which can be browsing through camera-quality images with the click-to-call feature. The advantage of ease of navigation and multimedia presentation format makes the one-level content browsing interface an ideal medium for product and service advertising.

To allow users to quickly scan through a set of data entry screens before beginning to type, a runtime executive of the invention can support a one-level data entry interface. In one embodiment of the one-level data entry interface, a runtime executive allows the right/left button clicks to open the next or previous view of the same record while performing any necessary data validation in the background and giving access to the main submenu from any view. Also, it allows the up/down button clicks to move the input focus to the previous or next data entry box on the current view. To keep typing at a minimum with a 10-key dial pad on a mobile device, the one-level data entry interface provides the data import function and context-sensitive copy-and-paste shortcuts. As a result, it can facilitate application usage by enabling data entry in arbitrary order across a set of tabs with background data validation while requiring less typing and fewer drilidowns.

Designing client applications is not all about GUI objects in nice screen layouts. The IDE of the invention allows designers to select scripting parameters to set up the workflow, business rules, and data model while constructing GUI objects for display screens from desired templates. The embodiment of the IDE also allows designers to compile the same application design into a set of data files containing the code that is compatible with the chosen mobile platform such as J2ME or BREW. When a client application is downloaded to a mobile device by a runtime executive, the runtime executive transforms this raw data into application databases and automatically sets itself up as the application. Thus, client applications are data streams that can be easily exchanged to support the pay-per-download subscription model. The advantages of having an easy-to-use IDE with the flexibility to change the design and scripts as often as needed, the ability to generate platform-compatible code, and the integration with runtime executives are : (a) ease of customization; (b) shorter time to market; and (c) less expensive to support.

### BRIEF DESCRIPTION OF THE DRAWINGS

These and other features will become more apparent in the following detailed description of embodiments of the present invention, in which reference is made to the appended drawings wherein:

FIG. 1 is a diagram of installing a runtime executive and the first IDE-generated client application according to an embodiment of the present invention;

FIG. 2 is a diagram of starting an application session or exchanging for another application according to an embodiment of the present invention;

FIG. 3 is a diagram of a one-level browsing interface according to an embodiment of the present invention;

FIG. 4 is a diagram of a one-level data entry interface according to an embodiment of the present invention; and

FIG. 5 is a diagram of defining and compiling scripts in an IDE according to an embodiment of the present invention.

### DETAILED DESCRIPTION OF THE INVENTION

In the following description, for the purposes of explanation, specific details are set forth in order to provide a thorough understanding of the invention. However, it will be apparent that the invention may be practiced without these specific details.

The present invention relates to techniques for: (a) building client applications on mobile devices with consistent graphical user interface (GUI) and application behavior within and across multiple mobile development platforms; and (b) supporting a pay-per-download subscription service. In one aspect of the invention, compact and shareable runtime executives are provided to deliver PC-like interactive navigation, multimedia presentations, and data manipulations in small footprints. In another aspect of the invention, an integrated development environment (IDE) is provided for designing client applications that can be compiled for various development platforms and loaded by runtime executives to speed up the ease of customization and the time to market.

According to an embodiment of the present invention, a runtime executive is an engine that can run client applications on mobile devices, wherein each client application is a set of data files generated in an IDE for a specific mobile platform. In such an embodiment, a runtime executive comprises a main module to manage client applications and the thread model; a page server to manage the stack, parser activities, remote and local SQL processing, object formation, and screen layout; and a controller to manage the input/output communications, application behavior, business logic, and screen display and to access to Component Object Model (COM) libraries. A runtime executive of the implementation is capable of downloading a client application to mobile devices, transforming the raw data into application databases, and then automatically setting itself up as the application. Thus, a runtime executive of such an embodiment can act as a loader for exchanging client application(s) under the same subscription service when instructed to do so by the web server.

According to an embodiment of the present invention, a runtime executive's main midlet or applet component performs eight important functions: (i) thread manager for multi-processing asynchronous tasks, synchronous processes, and monitor processes; (ii) interrupt processor of server and network events; (iii) error processing agent; (iv) application loader that downloads application files and publishes the application databases; (v) authentication agent; (vi) application boot manager for starting application from databases; (vii) session traffic controller; and (viii) persistent database manager.

According to an embodiment of the present invention, a runtime executive's page server performs nine important functions: (i) parser for application scripts; (ii) dynamic object generator; (iii) pre-parser command macro and remote procedure call manager; (iv) in-parser command macro and remote procedure call manager; (v) SQL manager for preparing SQL statements, executing SQL statements, and processing SQL cursors; (vi) metric interpretation agent for computing screen layouts; (vii) page stack manager; (viii) memory stack manager; and (ix) application script manager.

According to an embodiment of the present invention, a runtime executive's controller performs seven important functions: (i) state manager for mobile device screen; (ii) event manager that controls object class managers, inter-object navigation, screen transition, background script processing and redirection processes, screen activation, and screen unload; (iii) graphical render agent for painting screen display; (iv) content manager for scrolling screen content; (5) runtime command macro and remote procedure call manager; (vi) multimedia interface manager; and (vii) graphical font manager.

Each mobile development platform has unique features. In general, the J2ME platform has better memory management and allows applications to take advantage of its multi-thread interface, but it has slow and small data storage, no file-writing capability, and only a limited API for manipulating multimedia features, and keypad support. On the other hand, the BREW platform can have under-performing memory management and no multi-thread interface, but it offers large and fast data storage, file-writing capability, and broad range of multimedia APIs and keypad support. In order to implement client applications that look and operate the same way across multiple platforms, two separate runtime executives have been implemented to run IDE-generated client applications from the same platform and overcome the disk storage and file capacity restrictions set by the device manufacturers, the cell phone service providers (also known as carriers) and the underlying application platforms collectively. Although the runtime executives are customized for different platforms, the same application running on J2ME and Brew phones will have the same look and feel; more importantly, they behave the same.

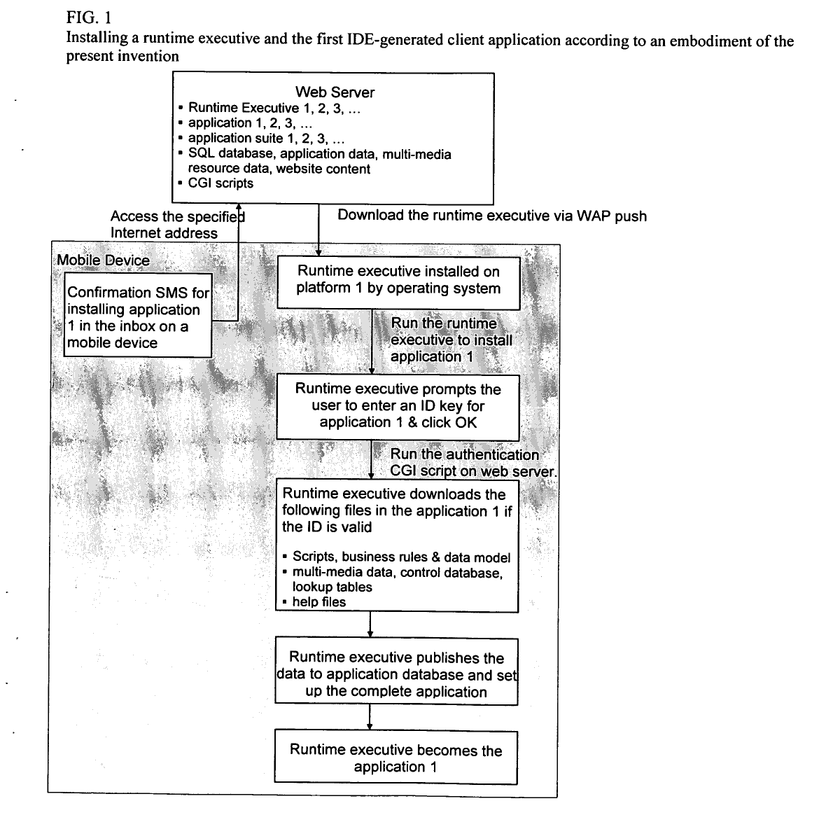

FIG. 1 illustrates the process of installing a runtime executive and the first IDE-generated client application according to an embodiment of the present invention. When a user subscribes to or purchases a client application, he will receive an SMS confirmation in the mobile device's inbox. When the user accesses the specified Internet address, a runtime executive for the same platform will be downloaded from the hosting website and then installed by the mobile device's operating system. If the user chooses to install the client application and passes the authentication setup, the runtime executive will download the target client application with a unique PIN. Once a download is completed, the data is published to application databases, and the runtime executive becomes that application—taking control of its business rules, application logic, data model and graphical user interface on the mobile device.

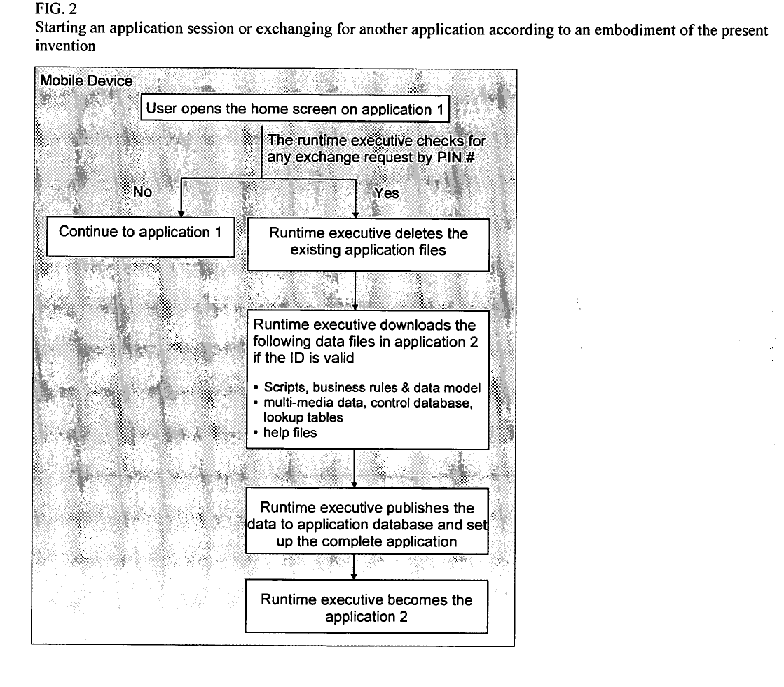

Since IDE-generated client applications are data files, subscribers can exchange applications through the pay-per-download model without having to install another executable, namely the runtime executive. Thus, the over-the-air download cost will be less. FIG. 2 illustrates the process of starting an application session or exchanging for another application according to an embodiment of the present invention. At the time of accessing a client application, a runtime executive will search the web server for any application exchange request that has been approved for the current user based on his PIN. If there is an outstanding request, a runtime executive will delete the current application databases, download the new application data files, republish the application databases, and then become the new application itself. The ease of exchange makes the pay-per-download embodiment of the current invention ideal for mobile users who want to alternate the access to several applications under the same subscription service and for those phone models that do not have a lot of disk space.

To deliver high-performance on resource-constrained mobile devices, business rules, and application logic and behavior are encoded into scripts that are parsed and executed at runtime. One embodiment of a page parser in a runtime executive provides precise timing and execution of commands and remote procedure calls within the current page, and before, during and after inter-page or page-to-script transitions. This allows an application to model more than one module (e.g., search, report, browse functions) with the same generic screen and customize its dynamic input and display behavior as well as script components appropriately for the intended functionality. Also, the page parser makes the data model functional and reliable, by addressing specification, management and data mining requirements. The data model specifies schema—the data variables and indexes of each table (e.g., type, domain, constraints); their inter-relationships and relationships between tables. The management scripts define pre-insert, pre-update, pre-delete, post-insert, post-update and post-delete triggers, and on-success URL and on-failure URL to ensure quality of the application's data. The data mining scripts process remote SQL data, local cache SQL, and local database SQL; they also analyze and compile complex query expressions that are behind the content galleries, reports and stylish layouts in the mobile screen.

With data communication protocols provided by the device's operating system, users can download information from Internet to mobile devices while having to drill down many submenus to find the information they want; to go back to previous data views, users typically repeat the data calls and incur multiple over-the-air charges. One embodiment of a one-level browsing interface provided by a runtime executive makes data access easy and useful by downloading the data just once and delivering information through a photo/content gallery with click-to-call and data manipulation functions.

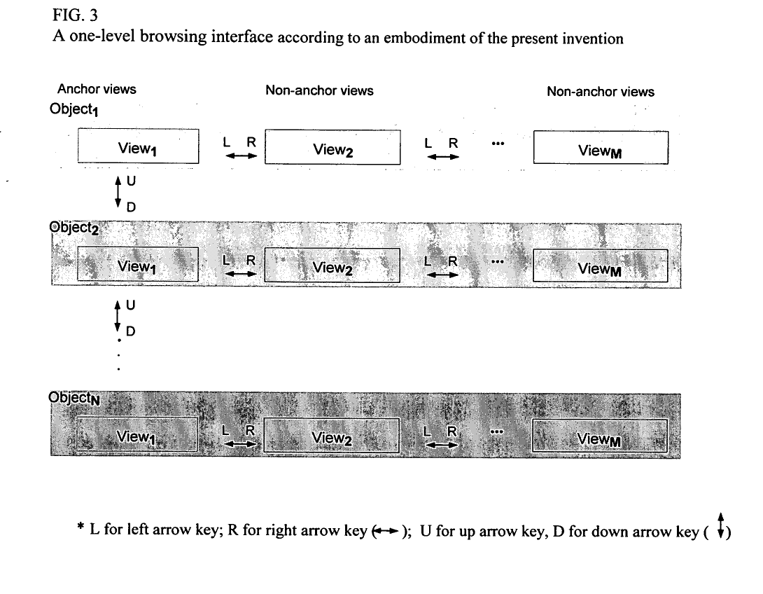

FIG. 3 illustrates a one-level browsing interface according to an embodiment of the present invention, wherein contents are a collection of objects in which each object is a collection of views with the first one as the anchor view. When a user chooses to browse his object collection in this embodiment, the anchor view is displayed for the initially selected object; he can click the right/left buttons to browse other detailed views of the object, or keep clicking the up/down buttons to go from one object to the next until he finds a particular object. Each non-anchor view is capable of scrolling if the content exceeds one screen's content capacity; if a view has attached data processing actions, the page server will perform the script commands and remote procedural calls before the final content is displayed. In such an embodiment, a runtime executive provides access to the browse function's submenu actions from any view by clicking its shortcut key. By attaching click-to-call command and monitoring browser usage with a CGI logging script, the embodiment of one-level photo/content gallery becomes an ideal multimedia advertising medium for showcasing products and services.

The ease of collecting data is taken for granted on PCs and notebooks. But on a mobile device with a small display screen, 10-key dial pad, slower micro-chip, no mouse pointer, and no multiple document interface (MDI), users often have to follow a rigid sequence of submenus to enter data and can potentially get confused, forget where they are, and simply cannot recall the data that they've entered recently. One embodiment of a one-level data entry interface provided by a runtime executive enables data entry in arbitrary order across a set of tabbed views at the same level with background data validation while requiring less typing and fewer drilldowns.

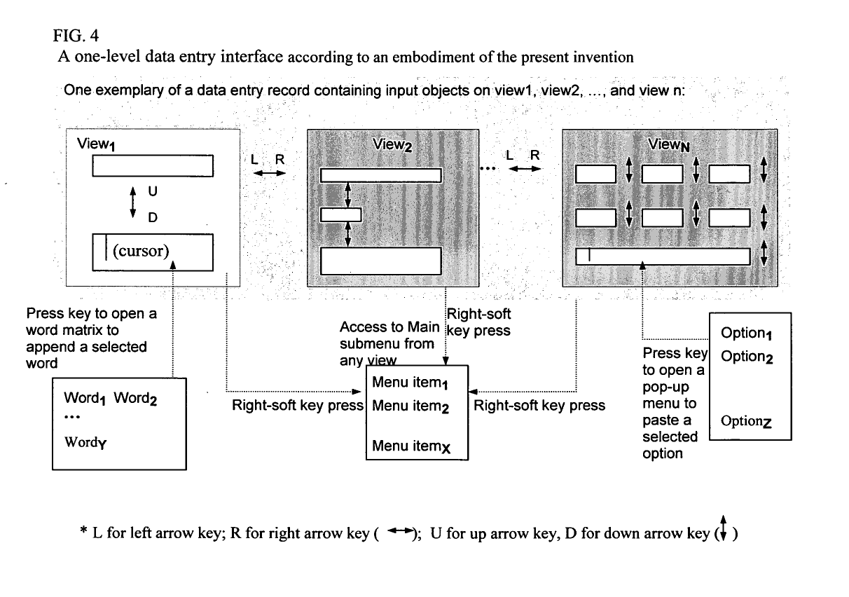

FIG. 4 illustrates the one-level data entry interface according to an embodiment of the present invention, wherein a record contains a set of views and each view contains a set of objects to collect data. When a user adds a record, he can start data entry from any view by clicking the right/left buttons successively to open the next or previous view of the same record. The transitions between views invoked by right/left button clicks are associated pre-validation actions, integrity assessment, success actions, failure actions, and query-unload actions, transparent to the users. Within each view, data collection objects are sequenced so a user can click the up/down buttons successively until the object of interest is the input focus. To provide more flexibility, one embodiment of the present invention enables access to the main submenu from any view, saves the current event definition and contact profile to cache memory from any view, and writes all events and contact profiles from cache memory to persistent databases with one key press. To minimize typing and drilldowns, such an embodiment can open a word matrix or an options pop-up with one key press for appending or pasting the selected item into the current text box; and support a data import method for copying the profile from a selected contact person into a set of data collection views of a record. In the embodiment, the local database caches encoded data entries by record key, so it is easy to retrieve the entire collection of raw data, decode, and display them on the screen in presentation style.

One embodiment of a one-level data entry interface implemented for a calendar object supports direct access without drilling down to a submenu to create, search, and view contacts and events; and publish contacts and events from cache to database.

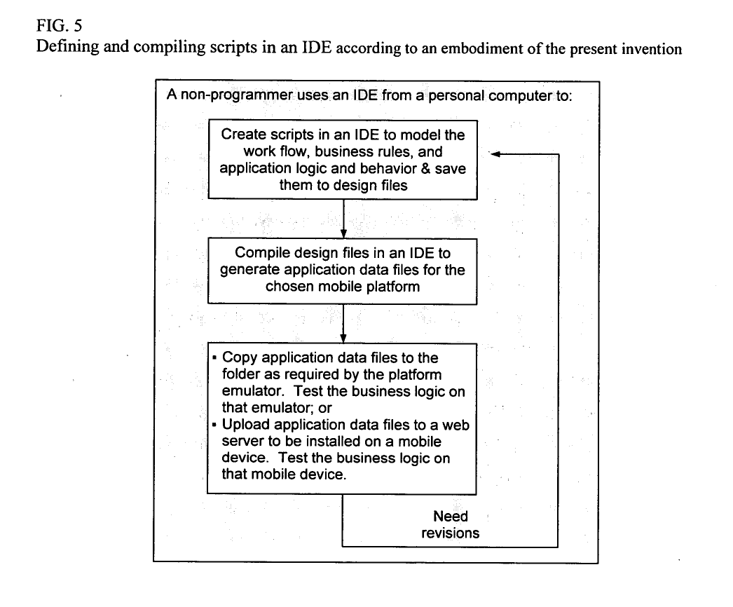

An IDE typically provides a set of tools essential for developing applications on a specific platform. On the J2ME platform, Sun's NetBeans Mobility Pack is used by computer programmers to develop applications for the GSM-network mobile phones; for CDMA-network mobile phones, Qualcomm's BREW SDK piggy-backs on Microsoft's Visual Studio for computer programmers to develop applications that run on the BREW platform. This invention's IDE can be used by non-programmers to design applications that support both J2ME and BREW platforms in the current embodiment. The current embodiment provides visual tools to prototype the GUI and command elements of a client application, browse each page in the IDE's emulator using sample data, and generate application code for either J2ME or BREW platform. To make visual designing even simpler, the invention's IDE allows a user to copy and paste design objects from any existing design, and declare any existing design as a template for creating new screens. FIG. 5 illustrates the process of defining and compiling scripts in an IDE according to an embodiment of the present invention. Once the application design is finalized and ready to use, a user can upload the application data files (including scripts, business rules, data model, multimedia data, control database, lookup tables, and help files) to a hosting website to be downloaded for subscriptions or purchases. When an IDE-generated client application gets installed on a mobile device, a runtime executive of the same platform transforms the application data files into databases and automatically sets itself up as the application and manages any subsequent application exchange request via a pay-per-download subscription service. The IDE embodiment of the present invention thus gives users that are not programmers the ability to design, compile, and deploy client applications and makes it easy to develop, market, and support client applications on mobile devices.

What is claimed is:

1. A method and system for designing, implementing, and managing client applications on mobile devices, said method and system comprising the following capabilities:
a) hosting one client application or a suite of distinct client applications with a single runtime executive that can be optimized for separate mobile development platforms;
b) designing and compiling client applications in an integrated development environment (IDE); and
c) managing the exchange of client applications through a pay-per-download subscription method over a data network

2. A method and system as recited in claim 1, wherein client applications that can be hosted by runtime executives are data files generated by an IDE for the same mobile development platform.

3. A method and system as recited in claim 1, wherein mobile devices are mobile telephones.

4. A method and system as recited in claim 1, wherein mobile development platforms include, but are not limited to, Java 2 Micro Edition (J2ME) from Sun of Santa Clara, Calif. and the Binary Runtime Environment for Wireless (BREW) from Qualcomm of San Diego, Calif.

5. A method and system as recited in claim 1, wherein a pay-per-download service is performed by a runtime executive acting as a loader for exchanging client applications under the same subscription service including, but not limited to, one application per exchange on the J2ME platform and a suite of applications per exchange on the BREW platform

6. A method and system as recited in claim 1, wherein the runtime executive further comprises a main module which can be, but is not limited to being, a midlet for the J2ME platform or an applet for the BREW platform to perform the following tasks:
a) thread manager for asynchronous, synchronous, and monitor processes;
b) interrupt processor of server and network events;
c) error processing agent;
d) application loader that downloads application files and publishes the application databases;
e) authentication agent;
f) application boot manager for starting application from databases;
g) session traffic controller; and
h) persistent database manager.

7. A method and system as recited in claim 1, wherein the runtime executive further comprises a page server to perform the following tasks:
a) managing the page stack, memory, and execution of scripts;
b) parsing application scripts;
c) performing command macros and remote procedure calls;
d) preparing and executing SQL statements, and processing the SQL cursor;
e) creating GUI objects; and
f) computing screen layouts.

8. A method and system as recited in claim 1, wherein the runtime executive further comprises a controller module for:
a) managing object events, inter-object navigation, background script process, re-direction, screen activation, and transition and unload;
b) painting the screen display;
c) computing screen content; and
d) managing multimedia interfaces.

9. A method and system as recited in claim 1, wherein the runtime executive further comprises a page parser for:
a) controlling data quality;
b) processing commands and making calls to the COM libraries with precise timing; and
c) processing remote SQL data, local cache SQL, and local database SQL statements.

10. A method and system as recited in claim 1, wherein the runtime executive further comprises a one-level browsing interface for:
a) using right/left button clicks to open the next or previous view of the same object;
b) using up/down button clicks to open to the anchor view of the previous or next object in the content gallery; and
c) performing any actions attached to a view.

11. A method and system as recited in claim 1, wherein the runtime executive further comprises a CGI logging script to track the click-to-call and download responses in association with one-level browsing content gallery to support a product/service advertising service.

12. A method and system as recited in claim 1, wherein the runtime executive further comprises a one-level data entry interface for:
a) using right/left button clicks to open the next or previous data collection view of a record;
b) using up/down button clicks to move the input focus to the previous or next object on the current data collection view; and
c) providing access to the main submenu from any data collection view of a record.

13. A method and system as recited in claim 1, wherein the runtime executive further comprises a single-key access method for: a) opening a word matrix or option menu related to the active text box; and b) copying the selected word or option into the active text box.

14. A method and system as recited in claim 1, wherein the runtime executive further comprises a data import method for copying the profile from a selected contact person into a set of data collection views of a record.

15. A method and system as recited in claim 1, wherein the runtime executive further comprises a direct access method from a calendar interface for creating, searching, and viewing contacts and events; and publishing contacts and events from cache to database.

16. A method and system as recited in claim 1, wherein the IDE further comprises a code generator to compile the same design file into different sets of data files for different mobile development platforms.

17. A method and system as recited in claim 1, wherein the IDE further comprises a script change method for updating work flow, business rules, and data model on the mobile device without necessitating code change on a runtime executive.
